(19) United States
(12) Patent Application Publication
(10) Pub. No.: US 2026/0122284 A1
(43) Pub. Date: Apr. 30, 2026

(54) METHOD OF ENCODING/DECODING FOR PERFORMING MACHINE VISION TASK AND COMPUTER READABLE RECORDING MEDIUM STORING INSTRUCTIONS FOR IMPLEMENTING ENCODING METHOD

(71) Applicant: Electronics and Telecommunications Research Institute, Daejeon (KR)

(72) Inventors: Sang Woon KWAK, Daejeon (KR); Soon Heung JUNG, Daejeon (KR); Jong Hwan KO, Suwon (KR); Chan Woong PARK, Suwon (KR); Seong Moon JEONG, Suwon (KR)

(73) Assignee: Electronics and Telecommunications Research Institute, Daejeon (KR)

(21) Appl. No.: 19/372,771

(22) Filed: Oct. 29, 2025

(30) Foreign Application Priority Data
Oct. 30, 2024 (KR) 10-2024-0151557

(51) Int. Cl. H04N 19/85; H04N 19/42

(52) U.S. Cl. CPC H04N 19/85; H04N 19/42

(57) ABSTRACT

According to a method of decoding an image to perform a machine vision task of the present disclosure, the method comprising decoding the image; applying a post-filter to a decoded image; obtaining, based on an output of the post filter, a restored image for the machine vision task, wherein the post-filter is trained based on a differentiable neural network based codec difference from a codec used to decode the image.

### BACKGROUND OF THE INVENTION

### Field of the Invention

The present disclosure relates to an image encoding/decoding method and device for performing a machine vision task.

### Description of the Related Art

Conventionally, video encoding/decoding technology has improved video compression efficiency and image quality by considering the human visual system. However, future video encoding/decoding technology is expected to be widely used not only for human vision but also in machine vision fields such as surveillance, intelligent transportation, smart cities, and intelligent industry.

Accordingly, there is a need to develop video encoding/decoding technology by which high-efficiency compression and recognition accuracy can be obtained by simultaneously considering human vision and machine vision.

### SUMMARY OF THE INVENTION

It is an object of the present disclosure to reduce amount of data to be encoded/decoded by pre-processing an input image.

It is a further object of the present disclosure to provide a method to train pre-filter network for pre-processing an input image and post-filter network.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of decoding an image to perform a machine vision task, the method comprising decoding the image; applying a post-filter to a decoded image; obtaining, based on an output of the post filter, a restored image for the machine vision task, wherein the post-filter is trained based on a differentiable neural network based codec difference from a codec used to decode the image.

In the method of decoding an image to perform a machine vision task according to the present disclosure, the pre-filter comprises a first branch composed of a deep learning neural network for image segmentation, a second branch connected to basic processing modules, and a skip connection that bypasses the first branch and the second branch.

In the method of decoding an image to perform a machine vision task according to the present disclosure, the post-filter is trained based on a loss function based on machine vision task performance.

In the method of decoding an image to perform a machine vision task according to the present disclosure, a pre-filter on an encoder side is used when training the post-filter.

In the method of decoding an image to perform a machine vision task according to the present disclosure, when the decoded image is in a first type format and the post-filter is trained based on an image in a second type format, the decoded image is converted into the second type format and then an image with a converted format is input to the post-filter.

In the method of decoding an image to perform a machine vision task according to the present disclosure, an image of the second type format output from the post-filter is reconverted to the first type format as an original format.

In the method of decoding an image to perform a machine vision task according to the present disclosure, when the decoded image has an image format in which sizes of a luma component image and a chroma component image are different, the chroma component image is upsampled to a size of the luma component image, and then an upsampled image is input to the post-filter.

In the method of decoding an image to perform a machine vision task according to the present disclosure, a chroma component image output from the post-filter is downsampled to an original size.

In accordance with an aspect of the present disclosure, the above and other objects can be accomplished by the provision of a method of encoding an image to perform a machine vision task, the method comprising applying a pre-filter to an input image; obtaining an encoding target image from an output image of the pre-filter; and encoding the encoding target image, wherein the pre-filter is trained based on a differentiable neural network based codec difference from a codec used to encode the input image.

In the method of encoding an image to perform a machine vision task according to the present disclosure, the pre-filter comprises a first branch composed of a deep learning neural network for image segmentation and a second branch connected to basic processing modules.

In the method of encoding an image to perform a machine vision task according to the present disclosure, the pre-filter is trained based on a first loss function based on a bitrate and a second loss function based on machine vision task performance.

In the method of encoding an image to perform a machine vision task according to the present disclosure, a weighted sum result of a first loss according to the first loss function and a second loss according to the second loss function is used for training the post-filter.

In the method of encoding an image to perform a machine vision task according to the present disclosure, when the input image is of a first type format and the pre-filter is trained based on an image of a second type format, the input image is converted to the second type format and then an image with a converted format is input to the pre-filter.

In the method of encoding an image to perform a machine vision task according to the present disclosure, an image of the second type format output from the pre-filter is reconverted to the first type format as an original format.

In the method of encoding an image to perform a machine vision task according to the present disclosure, when the input image has an image format in which sizes of a luma component image and a chroma component image are different, the chroma component image is upsampled to a size of the luma component image, and then an upsampled image is input to the pre-filter.

Meanwhile, in the present disclosure, it is possible to provide a computer-readable recording medium recording instructions for implementing the method of encoding/decoding

an image to perform a machine vision task.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of a video encoder according to an embodiment of the present disclosure.

FIG. 2 is a block diagram of a video decoder according to an embodiment of the present disclosure.

FIGS. 3 and 4 illustrate the configuration of an image encoder and an image decoder with additional components for applying preprocessing and postprocessing filters, according to an embodiment of the present disclosure.

FIG. 5 illustrates the structure of a pre-filter network according to an embodiment of the present disclosure.

FIG. 6 illustrates the structure of a post-filter network according to one embodiment of the present disclosure.

FIG. 7 is a diagram illustrating the training process of a pre-filter network according to an embodiment of the present disclosure.

FIG. 8 is a diagram illustrating the training process of a post-filter network according to an embodiment of the present disclosure.

FIG. 9 illustrates an example where a YUV format image is input to a filter network trained on images in RGB format.

FIG. 10 illustrates an example of upsampling a YUV420 image to a YUV444 image for training a filter network.

FIG. 11 is a flowchart of an image preprocessing method according to one embodiment of the present disclosure.

FIG. 12 is a flowchart of an image postprocessing method according to one embodiment of the present disclosure.

FIG. 13 illustrates an example of the pre-filter network and post-filter network proposed in this disclosure being applied to a system that encodes/decodes a feature map.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

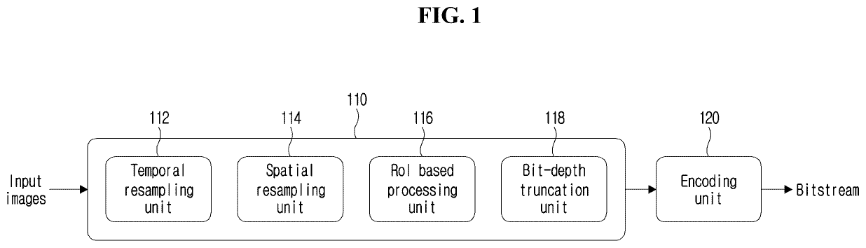

FIG. 1 is a block diagram of a video encoder according to an embodiment of the present disclosure.

Referring to FIG. 1, the video encoder may include a preprocessing unit 110 and an image encoding unit 120.

The preprocessing unit 110 performs a preprocessing process to convert input original images into images suitable for image encoding. Here, images input to the preprocessor 110 may be color or black-and-white images conforming to the YUV, RGB or YCbCr format.

The preprocessing unit 110 may include at least one of a temporal resampling unit 112, a spatial resampling unit 114, a Rol (region-of-interest)-based processing unit 116 or bit-depth truncation unit 118.

The temporal resampling unit 112 temporally resamples images. Only resampled images may be selected for image encoding. That is, encoding of some of the images input to the preprocessor 110 may be omitted through temporal resampling. For example, a 60 fps (frame per second) video may be converted into a 30 fps video by omitting odd-numbered images of the 60 fps video. Alternatively, images in a specific output order may be omitted by considering temporal redundancy between images.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The Rol-based processing unit 116 sets a region of interest in an image such that image encoding/decoding is performed focusing on information important to machine inference tasks. The region-of-interest-based processing unit 116 may remove a background region excluding the set region of interest or adjust the size and/or location of the region of interest in the image, so that the region of interest is set to be encoded/decoded with high quality.

The bit-depth truncation unit 118 performs bit depth truncation on the input image. Specifically, by performing a right-shifting operation on the input image, the amount of bits to be encoded may be reduced.

Meanwhile, the bit depth truncation may be performed on at least one of the color components.

For example, if a YUV format image is input, a 1-bit right-shifting operation may be performed only on the Y component.

The image encoding unit 120 encodes the image output from the preprocessing unit 110. Meanwhile, the image encoding unit 120 may encode the image using conventional codec technology or a codec technology modified based on the conventional codec technology for VCM (Video Coding for Machine). As an example, the image encoding unit 120 may encode the image based on HEVC, VVC, or AV1. As a result of image encoding, a bitstream is generated and the generated bitstream may be transmitted to a video decoder.

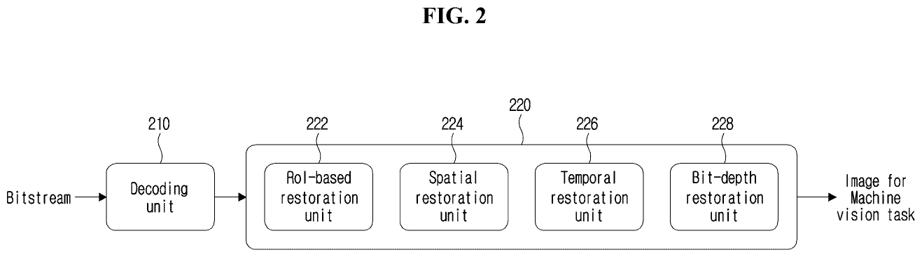

FIG. 2 is a block diagram of a video decoder according to an embodiment of the present disclosure.

Referring to FIG. 2, the video decoder may include an image decoding unit 210 and a post-processing unit 220.

The image decoding unit 210 decodes a bitstream received from the video encoding unit 110 to generate a decoded or reconstructed image. The image decoding unit 210 may decode the bitstream based on the codec technology used in the image encoding unit 120.

The post-processing unit 220 performs post-processing on the decoded image. Through post-processing, the size and frame rate of the images may be restored to match the original images.

The post-processing unit 220 may include at least one of a Rol-based reconstruction unit 222, a spatial reconstruction unit 224, a temporal reconstruction unit 226 or a bit-depth reconstruction unit 228.

The Rol-based reconstruction unit 222 obtains an image of the same size as an original image based on Rol information. For example, when a cropped image is encoded such that a region of interest is included therein, the decoded image has a different size from the original image. Accordingly, the Rol-based reconstruction unit 222 may adjust the retargeted image to the original size. Here, the retargeted image may represent a decoded image or an image on which upscaling has been performed through the spatial reconstruction unit 224. Alternatively, when the size or position of a region of interest in an encoding target image has been adjusted, the Rol-based reconstruction unit 222 may adjust the position and size of the region of interest in the retargeted image to match the original image.

The spatial reconstruction unit 224 performs upscaling on a decoded image. The decoded image may be reconstructed to be an image having the same size and/or spatial resolution as the original image through upscaling.

The temporal reconstruction unit 226 reconstructs an image at a temporal position where encoding/decoding has been omitted through temporal resampling. Specifically, the temporal reconstruction unit 226 may generate an image at a temporal position where encoding/decoding has been omitted through interpolation between decoded images.

The bit-depth reconstruction unit 228 restores the bit-depth of the input image to its original bit-depth. Specifically, by performing a left-shifting operation on the input image, the bit-depth of the input image may be restored to the original bit-depth.

Meanwhile, bit restoration may be performed on at least one of the color components.

For example, if a YUV format image is input, a 1-bit left-shifting operation may be performed only on the Y component.

Meanwhile, in order to perform reverse processing on the image processing performed in the preprocessor 110, additional information may be encoded and signaled. The post-processor 220 may perform post-processing on decoded images based on the additional information to generate images for machine inference. The additional information may be referred to as “metadata”.

Metadata may include at least one of temporal resampling information, spatial resampling information, or region-of-interest processing information.

The temporal resampling information may include at least one of a flag indicating whether temporal resampling has been performed or information indicating a temporal resampling rate.

For example, the flag indicates that temporal resampling has been performed when set to 1. In this case, information indicating a temporal resampling rate may be additionally encoded/decoded. When temporal resampling is performed, fewer images than the number of original images may be encoded/decoded. The video decoder can reconstruct images for which encoding/decoding has been omitted through temporal reconstruction.

On the other hand, the flag indicates that temporal resampling has not been performed when set to 0.

The temporal resampling rate may be represented as an exponent of 2. For example, a temporal resampling rate of 2\hat{ }N indicates that one of 2\hat{ }N images is selected as an encoding/decoding target image. For example, only images having a picture order count (POC) of a multiple of 2\hat{ }N can be encoded/decoded. Information representing the temporal resampling rate may represent the exponent (i.e., N) of the temporal resampling rate. As an example, the information may represent the exponent value of the temporal resampling rate or the value obtained by subtracting 1 from the exponent value.

The spatial resampling information may include at least one of a flag indicating whether spatial resampling has been performed or information indicating a scaling parameter for spatial resampling.

As an example, the flag indicates that spatial resampling has been performed when set to 1. In this case, information representing a scaling parameter may be additionally encoded. Specifically, information representing a horizontal scaling parameter and information representing a vertical scaling parameter may be encoded, respectively, and the encoded information may be signaled. When spatial resampling is performed, the size and/or spatial resolution of an image may be reduced. The video decoder may restore the size of a decoded image to the size of the original image or a pre-defined size, through spatial reconstruction. Meanwhile, information, indicating the pre-defined size, may be further encoded/decoded.

The flag indicates that spatial resampling has not been performed when set to 0.

The region-of-interest processing information may include at least one of image size information or region-of-interest information.

The image size information may include information indicating whether retargeting has been performed. If the retargeting flag is 1, it indicates that the retargeted image is encoded/decoded instead of the original image. On the other hand, if the retargeting flag is 0, it indicates that the original image is encoded/decoded as is.

The retargeted image indicates an image generated by performing at least one of resolution adjustment and position adjustment on at least one region of interest in the original image. Accordingly, the resolution or position of the region of interest in the retargeted image may be different from that of the original image. In addition, the size of the retargeted image may be the same as or smaller than that of the original image.

When retargeting is allowed (i.e., if the retargeting flag is 1), the size information of the retargeted image may be encoded/decoded. The size information of the retargeted image may include width information of the image and height information of the image.

Meanwhile, information indicating the size difference between the original image and the retargeted image may be additionally encoded/decoded. For example, information indicating whether a size difference between the size of the retargeted image and the size of the original image is encoded/decoded or not may be encoded/decoded.

For example, when the information, indicating whether the size difference is encoded/decoded or not, is 0, it indicates that the size difference between the retargeted image and the original image is not encoded/decoded. On the other hand, when the information, indicating whether the size difference is encoded/decoded or not, is 1, it indicates that the size difference between the retargeted image and the original image is encoded/decoded. In this case, information indicating the size difference between the size of the retargeted image and the size of the original image may be additionally encoded/decoded.

The information representing the size difference indicates the size difference between the original image and the retargeted image. Information representing the size difference in the horizontal direction and information representing a size difference in the horizontal direction may be encoded and signaled, respectively.

The region-of-interest information may include at least one of a flag indicating whether a region of interest is present, information on the number of regions of interest, a scaling parameter of a region of interest, or position information of a region of interest.

For example, when the flag is 1, it indicates that information on a region of interest may be encoded/decoded. In this case, at least one of the number of regions of interest, scaling parameter information of a region of interest, position information of a region of interest, or size information of a region of interest may be additionally encoded/decoded.

On the other hand, when the flag is 0, it indicates that a region of interest is not present.

The information on the number of regions of interest indicates the number of regions of interest. Meanwhile, the number of regions of interest may be calculated in units of image groups including at least one image.

A scaling parameter of a region of interest represents the scaling parameter with respect to the region of interest. Depending on the scaling parameter of the region of interest, the size of the region of interest may be adjusted.

Scaling parameter information of a region of interest may include information indicating whether the scaling parameter of the region of interest is updated. If the information, indicating whether the region of interest is updated or not, indicates that the scaling parameter of the region of interest will not be updated, the scaling parameter of the region of interest may be set to a default value or the same value as in the previous frame. On the other hand, when the information, indicating whether the region of interest is updated or not, indicates that the scaling parameter of the region of interest needs to be updated, the information indicating the scaling parameter of the region of interest may be additionally encoded/decoded.

Meanwhile, scaling parameter information of a region of interest may be encoded/decoded individually for each region of interest.

Position information of a region of interest indicates the position of the region of interest in the original image. The horizontal position (i.e., x-axis coordinate) information and vertical position (i.e., y-axis coordinate) information of the region of interest may be encoded/decoded.

Size information of a region of interest indicates the size of the region of interest in the original image. The horizontal size (i.e., width) information and the vertical size (i.e., height) information of the region of interest may be encoded/decoded.

As described above, according to the present disclosure, through the preprocessing/postprocessing process of the image, the encoding/decoding efficiency of the image may be improved while maintaining the machine task performance.

Meanwhile, the image preprocessing process illustrated in FIG. 1 and the image postprocessing process illustrated in FIG. 2 do not consider the compression distortion characteristics caused by the codec. Therefore, the present disclosure proposes a method that adds a step of applying a filter network that considers the compression distortion characteristics caused by the codec to the image preprocessing and image postprocessing processes.

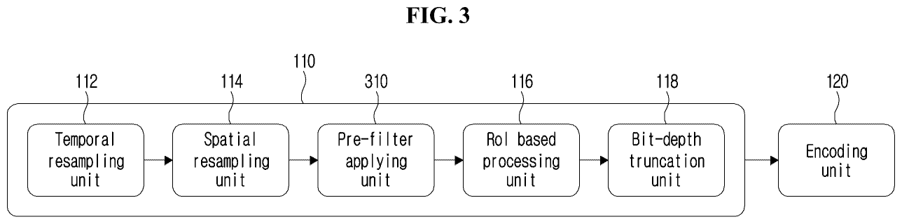

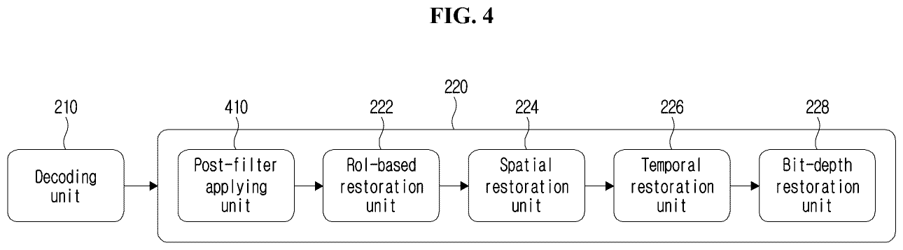

FIGS. 3 and 4 illustrate the configuration of an image encoder and an image decoder with additional components for applying preprocessing and postprocessing filters, according to an embodiment of the present disclosure.

For the application of the preprocessing filter, the image encoder may further include a pre-filter applying unit 310. The pre-filter applying unit 310 applies the preprocessing filter to the input image, thereby outputting an image optimized for machine vision performance.

Furthermore, for the application of the postprocessing filter, the image decoder may further include a post-filter applying unit 410. The post-filter applying unit 410 applies the postprocessing filter to the input image.

Meanwhile, in FIG. 3, the pre-filter applying unit 310 receives the output of the spatial resampling unit 114, and the output of the pre-filter applying unit 310 is input to the Rol-based processing unit 116. Unlike the illustrated example, the pre-filter applying unit 310 may be positioned before the spatial resampling unit 114, before the temporal resampling unit 112, after the Rol-based processing unit 116, or after the bit-depth truncation unit 118.

Furthermore, in FIG. 4, the post-filter applying unit 410 receives the reconstructed image output from the image decoding unit 210 and the output of the post-filter applying unit 410 is input to the Rol-based restoration unit. Unlike the illustrated example, the post-filter applying unit 410 may be positioned after the Rol-based restoration unit 222, after the spatial restoration unit 224, or after the temporal restoration unit 226. Meanwhile, the pre-filter applying unit 310 and the post-filter applying unit 410 may each have a network structure, and the weights for each node in the network may be learnable.

To train the pre-filter network and the post-filter network to reflect compression distortion resulting from image encoding/decoding, the end-to-end framework for training each filter network may include the codec used in the image encoding/decoding unit.

However, most commercial codecs (e.g., VVC, HEVC, or AV1) have a non-differentiable structure. Consequently, if the codec used in the image encoding/decoding unit is a commercial codec, the filter network cannot be trained based on it.

Therefore, the present disclosure proposes a method for using an alternative codec, replacing the codec used in the image encoding/decoding unit, at both ends of the filter network training framework.

In the present disclosure, the alternative codec may be a pre-trained Learned Image Compression (LIC) model. Specifically, the alternative codec may emulate the rate-distortion characteristics of the codec used in the image encoding/decoding unit. Accordingly, even when using the alternative codec, the pre-filter network may be trained to reflect the compression artifacts of the codec in the image encoding/decoding unit.

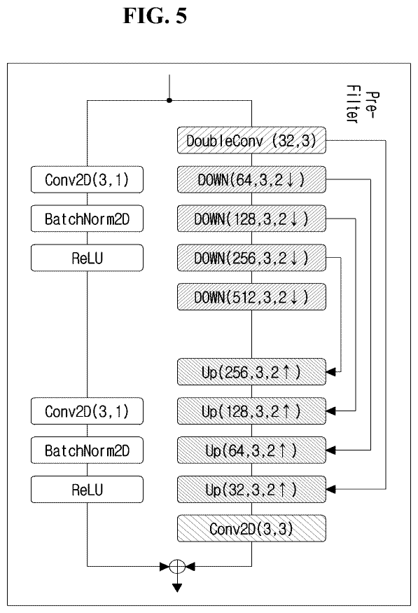

FIG. 5 illustrates the structure of a pre-filter network according to an embodiment of the present disclosure.

As shown in the example illustrated in FIG. 5, the pre-filter network has a structure in which two branches are connected in parallel. One of the two branches consists of a deep learning neural network (e.g., U-Net) for image segmentation, and the other consists of basic processing modules. Here, the basic processing module may consist of a convolution, a batch normalization, and an activation function.

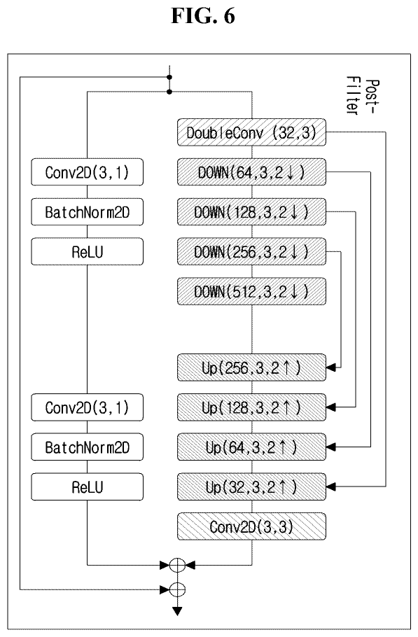

FIG. 6 illustrates the structure of a post-filter network according to one embodiment of the present disclosure.

Similar to the pre-filter network, the post-filter network includes a branch composed of a deep learning neural network (e.g., U-Net) for image segmentation and a branch with a structure connecting basic processing modules. The post-filter network may additionally include a skip connection for learning residuals.

In FIGS. 5 and 6, Conv2D (c, k) represents a convolutional layer with output channels c and a kernel size k.

DoubleConv(c, k) represents a module in which a 2D convolutional layer, batch normalization, and ReLU activation are repeated twice. c represents the number of output channels, and k represents the kernel size of the 2D convolutional layer. Down(c, k, s) represents a module that combines Max Pooling and DoubleConv(c, k). s represents the scale down factor of Max Pooling.

UP(c, k, s) represents a module that combines Transposed Convolution and DoubleConv(c, k). s represents the stride of the transposed convolution.

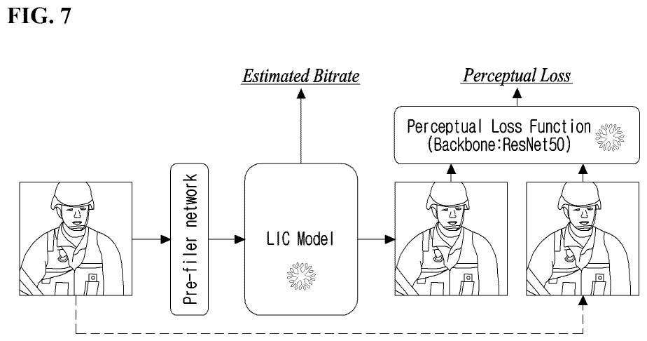

FIG. 7 is a diagram illustrating the training process of a pre-filter network according to an embodiment of the present disclosure.

The pre-filter network may use a differentiable neural network-based codec as a proxy. This allows it to simulate the compression distortion of the codec used in the image encoding/decoding unit.

The pre-filter network may be trained based on a loss function related to machine vision performance. For example, the pre-filter network may be trained based on a perceptual loss calculated based on the similarity between the feature map extracted from a neural network (exemplified by ResNet50 in FIG. 6) and the machine vision result.

Alternatively, the pre-filter network may be trained based on a loss function related to bitrate and a loss function related to machine vision performance. For example, the pre-filter network may be trained based on a loss L derived by combining a bitrate loss L_{bitrate} and a perceptual loss L_{perceptual} related to machine vision performance, as shown in Equation 1 below.

$$L = {L}_{bitrate} + λ \cdot {L}_{perceptual} \qquad [ Equation 1 ]$$

In Equation 1, λ represents the weight assigned to the perceptual loss L_{perceptual}.

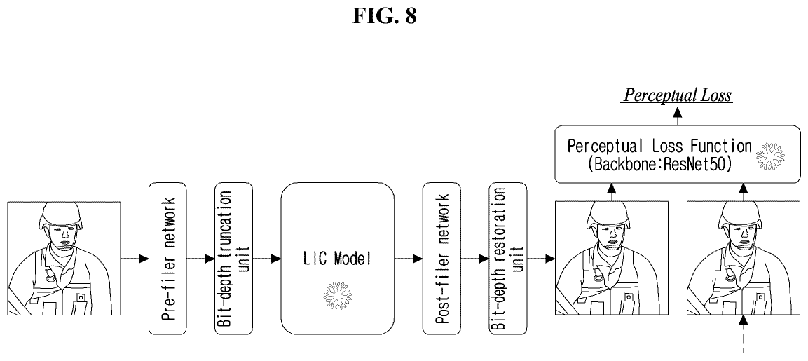

FIG. 8 is a diagram illustrating the training process of a post-filter network according to an embodiment of the present disclosure.

For training the post-filter network, not only a differentiable neural network-based codec but also a pre-filter network may be used. Furthermore, at least one unit for image pre-processing/post-processing may also be used for training the post-filter network. For example, in the example illustrated in FIG. 8, a bit-depth truncation unit and a bit-depth restoration unit are exemplified as being used for training the post-filter network.

If the input image is in YUV format, the bit-depth truncation unit may reduce the bit-depth by shifting the Y component to the right by one bit. In other words, by inputting an image with a bit-depth reduced by one bit in the training process, the post-filter network may be trained to perform appropriate filtering on the image with a reduced bit-depth.

The loss function used to train the post-filter network may be identical to the loss function used to train the pre-filter network. In other words, the post-filter network may also be trained using a loss function related to machine vision performance.

The pre-filter network and post-filter network may be trained based on images in RGB or YUV format.

Meanwhile, when an image in a second color format is input to a pre-filter network and/or post-filter network trained based on images in a first color format, the image in the second color format may be converted to an image in the first color format, and then the converted image in the first color format may be input to the pre-filter network and/or post-filter network. Here, one of the first and second color formats may represent the RGB format, and the other may represent the YUV format.

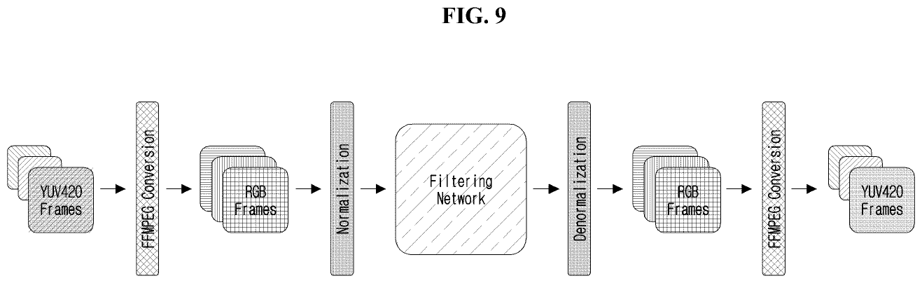

FIG. 9 illustrates an example where a YUV format image is input to a filter network trained on images in RGB format.

In FIG. 9, the filter network may represent a pre-filter network or a post-filter network.

Meanwhile, the format of the image output from the filter network is the same as the format of the input image. Accordingly, if the input image format is changed to match the format in which the filter network was trained, the filter network may reconvert the output image format back to its original format.

For example, in FIG. 9, the RGB image output from the filter network is exemplified as being reconverted to a YUV format.

If a YUV format image in which the chroma component image and luma component image have different sizes (i.e., an image in YUV422 or YUV420 format) is input, the chroma component image may be upsampled and/or downsampled to generate a YUV444 image, which may then be input to the filter network. In other words, the filter network may be trained based on the YUV444 image.

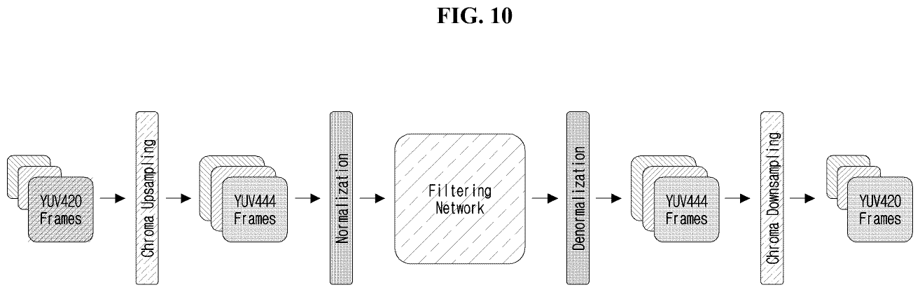

FIG. 10 illustrates an example of upsampling a YUV420 image to a YUV444 image for training a filter network.

As shown in the example shown in FIG. 10, a YUV420 image may be upsampled to obtain a YUV444 image, and then the YUV444 image may be input to the filter network.

Meanwhile, the image output from the filter network has the same size as the input of the filter network (i.e., a YUV444 image). Therefore, to restore the image output from the filter network to the same size as the original image, the YUV444 image (specifically, the chroma component image of YUV444 image) may be downsampled to obtain a YUV420 image.

Similarly, even when a YUV format image with different chroma and luma component sizes is input to a filter network trained on a YUV444 image, the chroma component image may be upsampled and/or downsampled to generate a YUV444 image.

Alternatively, the filter network may be trained based on YUV420 or YUV422 images. If the input image is not a YUV420 or YUV422 image, upsampling or downsampling may be performed on the input image to adjust the size of the chroma component image of the input image.

Information indicating whether the filter network proposed in the present disclosure is to be used may be encoded and signaled.

For example, the information may be a flag indicating whether a pre-filter network and/or a post-filter network are to be used.

Furthermore, the information may include information regarding at least one of an operating patch size of a filter, a learning characteristic of a filter, or a color format of the image processed by the filter, so that the pre-filter network and the post-filter network can operate jointly. Here, the the learning characteristic of the filter may indicate a model version based on the hyperparameters used during the training of the filter network.

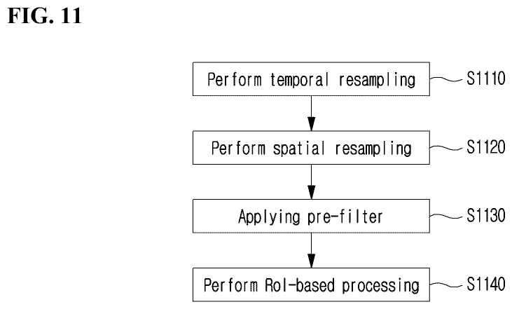

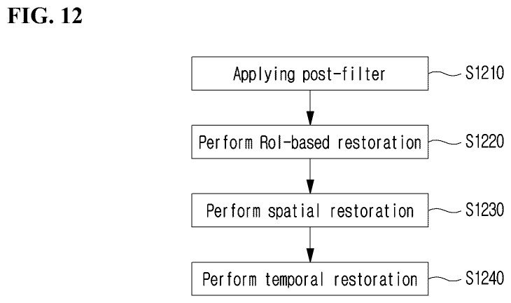

FIG. 11 is a flowchart of an image preprocessing method according to one embodiment of the present disclosure, and FIG. 12 is a flowchart of an image postprocessing method according to one embodiment of the present disclosure.

Referring to FIG. 11, when an image is input, temporal resampling may be performed on the input image S1110. Spatial resampling may be performed on the remaining pictures through temporal resampling S1120, and a pre-filter may be applied to the image on which spatial resampling has been performed S1130. Subsequently, Rol-based processing may be performed on the image to which the pre-filter has been applied S1140.

Meanwhile, as described above, applying the pre-filter may be performed before temporal resampling, before spatial resampling, or after Rol-based processing.

Referring to FIG. 12, when an image is decoded, a post-filter may be applied to the decoded image S1210. Rol-based restoration may be performed on the image to which the post-filter has been applied S1220, and spatial restoration may be performed on the image where the ROI-based restoration was performed S1230. Subsequently, temporal restoration may be performed to additionally generate images at the time points where encoding/decoding was omitted S1240.

Meanwhile, as previously described, applying the post-filter may be performed after performing ROI-based restoration, after performing spatial restoration, or after performing temporal restoration.

The pre-filter network and post-filter network proposed in this disclosure may also be applied to systems that encode/decode a feature map (e.g., Feature-based Video Coding for Machines (FCM) systems) to perform machine vision tasks based on a feature map.

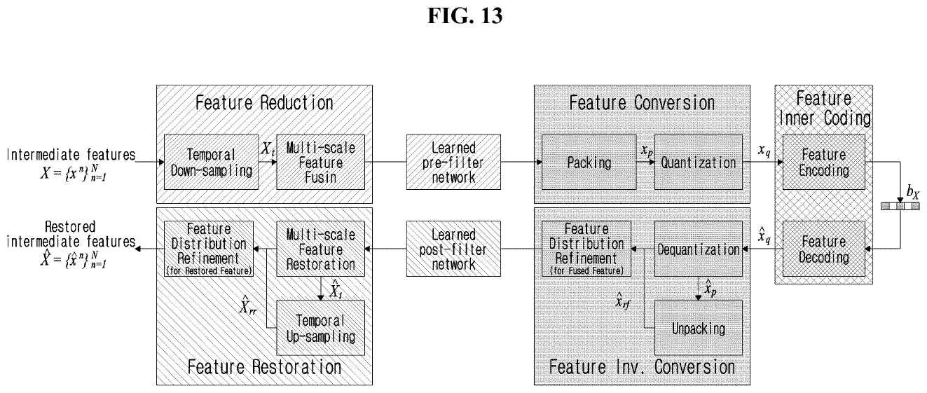

FIG. 13 illustrates an example of the pre-filter network and post-filter network proposed in this disclosure being applied to a system that encodes/decodes a feature map.

In the example illustrated in FIG. 12, the pre-filter network i depicted as being located between the feature reduction step and the feature conversion step, and the post-filter network is located between the feature inversion conversion step and the feature restoration step.

However, a location of the pre-filter network and post-filter network are not limited to the illustrated example. For example, the pre-filter network may be positioned to receive the output of the feature conversion step, or the post-filter network may be positioned to receive decoded features.

According to the present disclosure, amount of data to be encoded/decoded can be reduced through the pre-processing of the input image.

According to the present disclosure, a method of training the pre-filter to pre-processing the input image and the post-filter can be provided.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of decoding an image to perform a machine vision task, the method comprising:
decoding the image;
applying a post-filter to a decoded image;
obtaining, based on an output of the post filter, a restored image for the machine vision task,
wherein the post-filter is trained based on a differentiable neural network based codec difference from a codec used to decode the image.

2. The method of claim 1, wherein the pre-filter comprises a first branch composed of a deep learning neural network for image segmentation, a second branch connected to basic processing modules, and a skip connection that bypasses the first branch and the second branch.

3. The method of claim 1, wherein the post-filter is trained based on a loss function based on machine vision task performance.

4. The method of claim 1, wherein a pre-filter on an encoder side is used when training the post-filter.

5. The method of claim 1, wherein when the decoded image is in a first type format and the post-filter is trained based on an image in a second type format, the decoded image is converted into the second type format and then an image with a converted format is input to the post-filter.

6. The method of claim 5, wherein an image of the second type format output from the post-filter is reconverted to the first type format as an original format.

7. The method of claim 1, wherein when the decoded image has an image format in which sizes of a luma component image and a chroma component image are different, the chroma component image is upsampled to a size of the luma component image, and then an upsampled image is input to the post-filter.

8. The method of claim 7, wherein a chroma component image output from the post-filter is downsampled to an original size.

9. A method of encoding an image to perform a machine vision task, the method comprising:
applying a pre-filter to an input image;
obtaining an encoding target image from an output image of the pre-filter; and
encoding the encoding target image,
wherein the pre-filter is trained based on a differentiable neural network based codec difference from a codec used to encode the input image.

10. The method of claim 9, wherein the pre-filter comprises a first branch composed of a deep learning neural network for image segmentation and a second branch connected to basic processing modules.

11. The method of claim 9, wherein the pre-filter is trained based on a first loss function based on a bitrate and a second loss function based on machine vision task performance.

12. The method of claim 11, wherein a weighted sum result of a first loss according to the first loss function and a second loss according to the second loss function is used for training the post-filter.

13. The method of claim 9, wherein when the input image is of a first type format and the pre-filter is trained based on an image of a second type format, the input image is converted to the second type format and then an image with a converted format is input to the pre-filter.

14. The method of claim 13, wherein an image of the second type format output from the pre-filter is reconverted to the first type format as an original format.

15. The method of claim 9, wherein when the input image has an image format in which sizes of a luma component image and a chroma component image are different, the chroma component image is upsampled to a size of the luma component image, and then an upsampled image is input to the pre-filter.

16. A non-transitory computer readable recording medium storing instructions for encoding an image to perform a machine vision task, when the instructions are executed cause the computer to carry out:
applying a pre-filter to an input image;
obtaining an encoding target image from an output image of the pre-filter; and
encoding the encoding target image,
wherein the pre-filter is trained based on a differentiable neural network based codec difference from a codec used to encode the input image.
